(19) United States
(12) Patent Application Publication
(10) Pub. No.: US 2005/0156858 A1
(43) Pub. Date: Jul. 21, 2005

(54) Driving circuit of liquid crystal display

(76) Inventors: Seong Jun Ahn, Kyoungki-do (KR); Cheon Hong Kim, Seoul (KR); Se Jong Yoo, Kyoungki-do (KR)

Correspondence Address: LADAS & PARRY LLP, 224 SOUTH MICHIGAN AVENUE, SUITE 1200, CHICAGO, IL, 60604, US

(21) Appl. No.: 11/013,051

(22) Filed: Dec. 15, 2004

(30) Foreign Application Priority Data
Dec. 30, 2003 (KR) 2003-100226

(51) Int. Cl. G09G 3/36

(52) U.S. Cl. 345/100

(57) ABSTRACT

Disclosed is a driving circuit of a liquid crystal display having a stable operation characteristic. The driving circuit comprises first and second transistors connected in series with each other between an output terminal of an (N−1)^{th} circuit and a Vss terminal, a third transistor operated by a clock signal and having a drain for receiving an inversion signal of the clock signal and a source connected to an N^{th} gate line, a fourth transistor having a drain connected to the source of the third transistor and a source connected to the Vss terminal, fifth and sixth transistors connected in series with each other between a VDD terminal and the Vss terminal, a seventh transistor operated by an output signal of an (N+1)^{th} circuit, an eighth transistor operated by an output signal of an (N+1)^{th} circuit, a first capacitor formed at a front terminal of a gate of the third transistor, and a second capacitor formed between a gate and a drain of the sixth transistor.

### BACKGROUND OF THE INVENTION

1. Field of the invention

The present invention relates to a driving circuit of a liquid crystal display, and more particularly to a driving circuit of a liquid crystal display in which the operation characteristic of the driving circuit is greatly improved by stabilizing an OFF level of an output signal and by significantly improving characteristic variation of a device resulting from DC voltage stress.

2. Description of the Prior Art

As generally known in the art, CRTs (Cathode Ray Tubes), which are a kind of display device, have been mainly used as a monitor for various instrumentation devices, information terminals as well as televisions, etc., but they cannot sufficiently satisfy the demand for compact sizes and light weights of electronic devices, owing to the inherent weight and size of a CRT itself.

In order to replace a CRT, various liquid crystal displays having a lightweight, a slimmer thickness and a compact size, have been actively developed. Recently, such liquid crystal displays have been developed to an extent that they may serve as flat panel displays, so that the demand for liquid crystal displays have been greatly increased.

As shown in FIG. 1, a liquid crystal display includes a plurality of gate lines and a plurality of data lines which intersect each other. In addition, the liquid crystal display includes an LCD (Liquid Crystal Display) panel 11 having thin film transistors disposed at positions at which each gate line and each data line are intersected so as to display an image, a source driver IC 13 for applying a driving voltage to drive the data lines of the LCD panel 11, and a gate driver IC 15 for applying a driving voltage to drive the gate lines of the LCD panel 11.

Although it is not shown, the liquid crystal display includes peripheral circuits for providing various control signals to the source driver IC 13 and the gate driver IC 15, and such peripheral circuits include an LVDS section, a timing controller, etc.

Among such liquid crystal displays, an amorphous-silicon AMLCD (Active Matrix Liquid Crystal Display) has advantages of a reduced fabrication cost, compactness, and lightweight, in spite of low mobility and relatively high threshold voltage and parasitic capacitance, as compared with a polysilicon LCD in view of a driving circuit integration technique. Therefore, many researches of the amorphous-silicon AMLCD have been made. Recently, it becomes possible to construct an active matrix of a driving circuit only with amorphous-silicon TFTs, by means of new design technique and process.

In general, a gate line driving voltage is outputted from the gate driver IC, and the gate driver IC includes a shift register, a level shift, and a buffer. However, amorphous-silicon row driver must integrate the functions of these devices with only a shift register.

A shift register of a well-known amorphous-silicon row driver includes four to six transistors, in which the transistors must be designed in mutually different sizes.

Hereinafter, a driving circuit of the conventional liquid crystal display will be described with reference to the accompanying drawings.

FIG. 2 is a view showing a first conventional driving circuit of a liquid crystal display in which a shift register includes six transistors, and FIG. 3 is a timing view for showing operations of the circuit shown in FIG. 2.

First, a driving circuit of the conventional liquid crystal display includes six thin film transistors Tp, Td, Ts, Tr, T1, and Tz. In the driving circuit of the liquid crystal display, since an input signal has a high level at T0, a node P2 has a high level, so that a thin film transistor Tz is turned on. At this time, a point A of an output side is biased to a low level by means of a Vss voltage.

Then, when both of an input signal Vi and a clock signal Φ2 have a high level, the thin film transistors Tp, Tr, and Ts are simultaneously turned on. At this time, a node P1 becomes positive and has a voltage value obtained by subtracting a threshold voltage of the thin film transistor Tp from a VDD voltage.

Meanwhile, the node P2 becomes a low level owing to a powerful turning on of the thin film transistor Tr. For reference, the thin film transistor Tr has a size larger than a size of the thin film transistor Ts by ten times.

When the node P2 is shifted into a low level, the thin film transistor Tz is turned off, but the output is still maintained at a low level. The reason is that a clock signal Φ1 has a low level.

Meanwhile, when the clock signal Φ1 is shifted into a high level, the thin film transistor T1 becomes a precharged high state, and the voltage of the node P1 becomes approximately 90% of (VDD−Vth)+Φ1. At this time, since an output voltage Vo follows the pulse of the clock signal Φ1, the output voltage Vo is turned on, so that a shift register function applying a high-level voltage as an input to the next-stage circuit is performed.

In addition, when the clock signal Φ2 becomes a high level, the node P2 becomes a high level and the thin film transistor Tz is turned on, so that the point A of the output side becomes a low level.

Meanwhile, FIG. 4 is a view showing a second conventional driving circuit of a liquid crystal display in which the second conventional driving circuit includes four thin film transistors and two capacitors C1 and C2, unlike the first conventional driving circuit of FIG. 2 including six thin film transistors.

The operation principle of the driving circuit of a liquid crystal display shown in FIG. 4 is similar to that of the above-mentioned first conventional driving circuit including six thin film transistors, but differs in that a reset signal is applied by receiving an output signal of the next stage.

However, the conventional driving circuits of a liquid crystal display have problems as follows.

First, in the case of the first conventional driving circuit including six thin film transistors, since the thin film transistors Td and Tz for resetting use continuous clock signals as their gate voltages, the thin film transistors Td and Tz sequentially receive DC stress due to high-level voltages of the clock signals, so that when the driving circuit is driven for a long time, characteristic variation of the thin film transistors, such as variation of the threshold voltage, may occur, thereby causing a malfunction of the circuit.

Also, in the case of the second conventional driving circuit including four thin film transistors and two capacitors, a thin film transistor T4, which performs a reset function by an output signal of the next stage, enters an ON state for only one scan period of time but enters a floating state for rest of the time period of the frame. Consequently, a capacitive coupling is created by a voltage of an image signal applied through the data line, thereby causing a fluctuation phenomenon according to variation of electric potential of an image signal without having a V_{goff} characteristic requiring a constant voltage for a predetermined period of time. Such a phenomenon causes an image flickering when the panel is subject to a line inversion drive, thereby significantly deteriorating the quality of the image.

### SUMMARY OF THE INVENTION

Accordingly, the present invention has been made to solve the above-mentioned problems occurring in the prior art, and an object of the present invention is to provide a driving circuit of a liquid crystal display having a stable operation characteristic, by improving the V_{goff} characteristic which is unstable in a conventional driving circuit including four thin film transistors and two capacitors and by minimizing the characteristic variation of the thin film transistors caused by DC stress which occurs in a conventional driving circuit including six thin film transistors.

In order to accomplish this object, there is provided a driving circuit of a liquid crystal display, the driving circuit comprising: first and second transistors connected in series with each other between an output terminal of an (N−1)^{th} circuit and a Vss terminal; a third transistor operated by a clock signal, and having a drain for receiving an inversion signal of the clock signal and a source connected to an N^{th} gate line; a fourth transistor having a drain connected to the source of the third transistor and a source connected to the Vss terminal; fifth and sixth transistors connected in series with each other between a VDD terminal and the Vss terminal; a seventh transistor operated by an output signal of an (N+1)^{th} circuit, and having a drain and a source connected to a drain and a source of the second transistor, respectively; an eighth transistor operated by an output signal of an (N+1)^{th} circuit, and having a drain and a source connected to a drain and a source of the fifth transistor, respectively; a first capacitor formed at a front terminal of a gate of the third transistor; and a second capacitor formed between a gate and a drain of the sixth transistor.

Herein, operation states of the first and sixth transistors are determined according to an output signal of the (N−1)^{th} circuit, operation states of the seventh and eighth transistors are determined according to an output signal of the (N+1)^{th} circuit, operation states of the third transistor are determined according to the clock signal, operation states of the second and fourth transistors are determined according to a drain voltage of the sixth transistor, and operation states of the fifth transistor are determined according to a VDD voltage.

In addition, the VDD voltage has a voltage range for allowing gate-source voltages larger than threshold voltages of the second, fourth, and fifth transistors to be applied to the second, fourth, and fifth transistors.

In addition, the seventh transistor is a reset transistor, which is operated by an output signal of the (N+1)^{th} circuit, and the eighth transistor is a transistor for transferring the VDD voltage, which is operated by the output signal of the (N+1)^{th} circuit.

In addition, the first capacitor stabilizes an OFF characteristic of a signal outputted to an N^{th} gate line, and the second capacitor stabilizes a level of a drain voltage of the sixth transistor.

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing a construction of a conventional liquid crystal display;

FIG. 2 is a view showing a construction of a conventional driving circuit of a liquid crystal display including six thin film transistors;

FIG. 3 is a timing view for showing operations of the circuit shown in FIG. 2;

FIG. 4 is a view showing a construction of a conventional driving circuit of a liquid crystal display including four thin film transistors and two capacitors;

FIG. 5 is a view showing a construction of a driving circuit of a liquid crystal display according to one embodiment of the present invention; and

FIGS. 6A and 6B are views showing simulation waveforms of the driving circuit of the liquid crystal display according to one embodiment of the present invention.

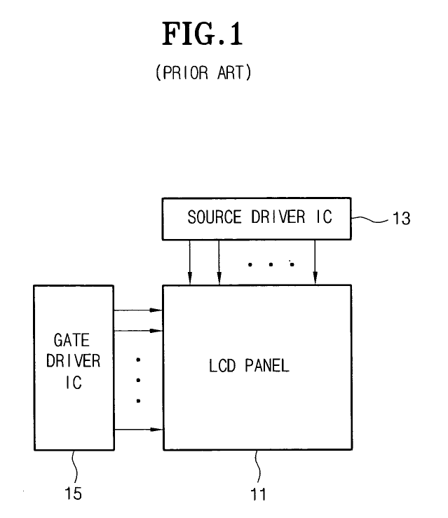

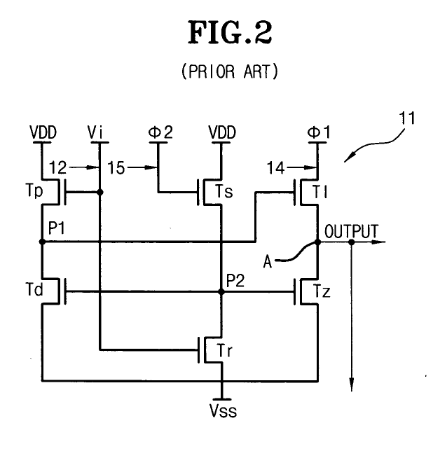

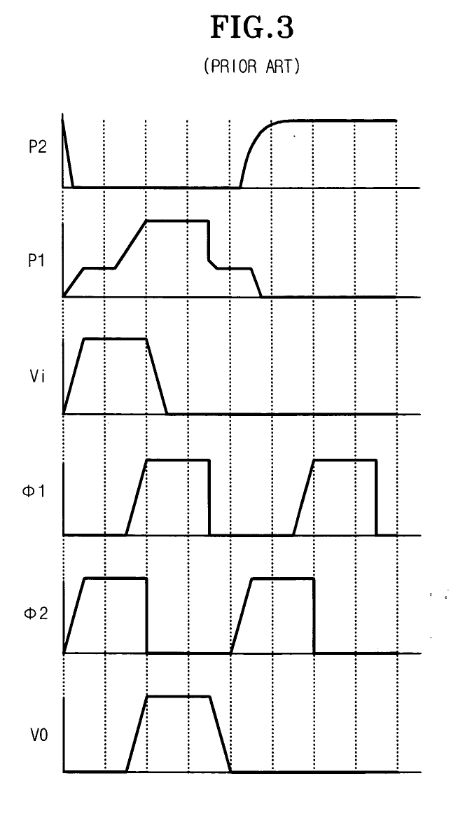

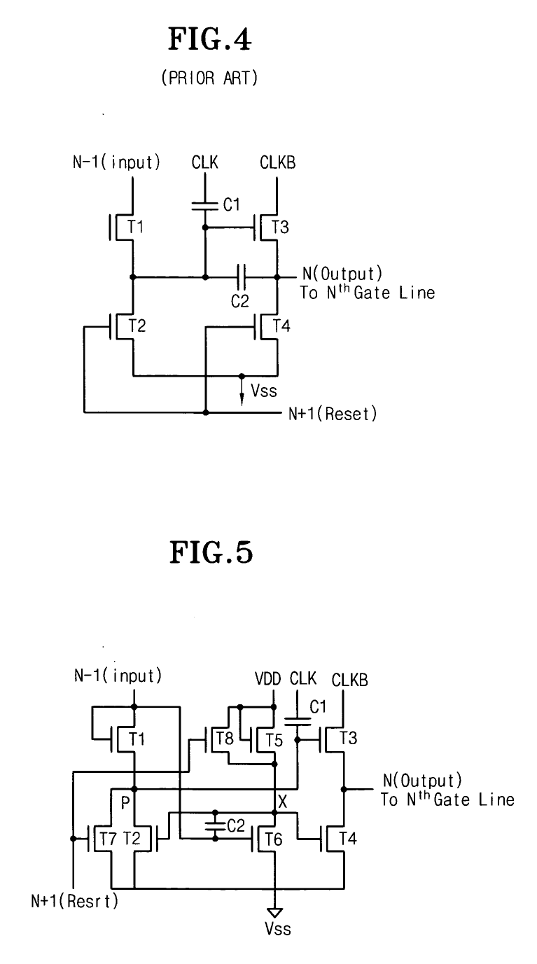

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

FIG. 5 is a driving circuit of a liquid crystal display according to one embodiment of the present invention.

Referring to FIG. 5, a driving circuit of a liquid crystal display according to the present invention includes eight thin film transistors T1, T2, T3 T4, T5, T6, T7, and T8 and two capacitors C1 and C2.

As shown in FIG. 5, the gate terminal and the drain terminal of the first transistor T1 are connected together to an (N−1)^{th} gate line, the second transistor T2 is connected between the source of the first transistor T1 and a Vss terminal. In addition, the third transistor T3 operated by a clock signal CLK is connected with the fourth transistor T4 in series, in which the source terminal of the fourth transistor T4 is connected to the Vss terminal. Herein, a contact point between the source terminal of the third transistor T3 and the drain terminal of the fourth transistor T4 is an output terminal N, and a voltage outputted through the output terminal is applied to an N^{th} gate line. Also, an inverted clock signal CLKB signal is applied to the drain terminal of the third transistor T3.

Meanwhile, the fifth transistor T5 and the sixth transistor T6 are connected in series with each other between a VDD terminal and the Vss terminal. The seventh transistor T7 and the eighth transistor T8, operation states of which are determined by a reset signal, connected in parallel with each other.

In addition, a VDD voltage is applied to the drain terminal of the eighth transistor T8 whose operation state is determined by the reset signal. The drain terminal of the eighth transistor T8 and the gate terminal of the fifth transistor T5 are connected together to the VDD terminal.

Meanwhile, the first capacitor C1 is connected to the gate terminal of the third transistor T3. That is, one electrode of the first capacitor C1 is connected so as to receive the clock signal, and the other electrode of the first capacitor C1 is connected to the gate terminal of the third transistor T3.

The gate terminal of the second transistor T2 is connected to both of the drain terminal of the sixth transistor T6 and the gate transistor of the fourth transistor T4. One electrode of the second capacitor C2 is connected to the drain terminal of the sixth transistor T6, and the other electrode of the second capacitor C2 is connected to both of the drain terminal of the first transistor T1 and the gate terminal of the sixth transistor T6.

In the following description, the operation of the above-mentioned driving circuit of the liquid crystal display according to the present invention will be described.

As shown in FIG. 5, the driving circuit of the liquid crystal display according to the present invention includes eight transistors and two capacitors, in which the respective thin film transistors have different sizes and different functions from each other.

According to the operation sequence of the driving circuit, first, an output signal of an (N−1)^{th} circuit (not shown) is inputted through the drain terminal of the first transistor T1.

When the output signal of the (N−1)^{th} circuit (not shown), which is an input signal from the viewpoint of an N^{th} circuit in the present driving circuit, is inputted through the drain terminal of the first transistor T1, the clock signal CLK is also inputted in synchronization with the input signal.

At this time, if the input signal has a high level, the first transistor T1 and the sixth transistor T6 are turned on, and a node P becomes a positive level and has an electric potential obtained by subtracting the threshold voltage of the first transistor T1 from the VDD voltage. At this time, a DC voltage of the VDD, which is a voltage higher than a Vss voltage by a few volts, is continuously applied through the fifth transistor T5, and simultaneously, a node X enters a low level owing to a powerful turning on of the sixth transistor T6. For reference, the sixth transistor T6 has a larger size than the fifth transistor T5 by about ten times or more.

Since the node X has a low level, the fourth transistor T4 is in an OFF state, but the output terminal N is still maintained because the inverted clock signal CLKB is at a low level.

Meanwhile, when an output signal of an (N+1)^{th} circuit is applied to the seventh transistor T7 and the eighth transistor T8 as a reset signal, seventh and eighth transistors T7 and T8 causes decay of the node P together with the second transistor T2. At this time, the eighth transistor T8 is arranged to improve the reset function since the turning on voltage of the fifth transistor T5 is relatively low.

Herein, the capacitance of the second capacitor C2 is decided so as to function to stabilize the level of the electric potential of the node X, and the capacitance of the first capacitor C1 is decided so as to function to stabilize the OFF level characteristic of the output signal.

With the driving circuit of the liquid crystal display according to the present invention as described above, owing to the continuously applied VDD voltage, which is a voltage that is higher than the Vss voltage by a few volts, the gate-source voltages Vgs of the fourth transistor T4 is driven at a relatively lower voltage as compared with the conventional art.

Referring to the construction of the above-mentioned circuit, an output signal of the (N−1)^{th} circuit, which is an input signal from the viewpoint of the present circuit, not only is inputted only simultaneously both the gate terminal and the drain terminal of the first transistor T1 so that the first transistor T1 may function as a diode, but also is inputted to the gate terminal of the sixth transistor T6.

The source terminal of the first transistor T1 is connected to both of the drain terminal of the second transistor T2, which is a reset transistor, and the gate terminal of the third transistor T3, which is a driving transistor. In addition, the source terminals of the second transistor T2, the fourth transistor T4, and the sixth transistor T6 are together connected to the Vss terminal.

The inverted clock signal CLKB is applied to the drain terminal of the third transistor T3, which is a driving transistor. The source electrode of the third transistor T3 is connected to the drain electrode of the fourth transistor T4, and outputs a signal for switching the drive of a gate line.

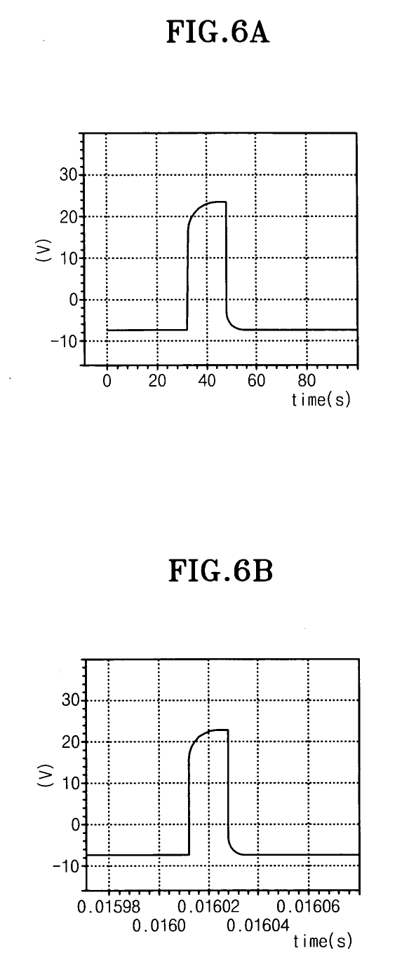

For reference, FIGS. 6A and 6B are views showing simulation waveforms of the driving circuit of the liquid crystal display according to the present invention.

As described above, the driving circuit of the liquid crystal display of the present invention can realize a stable shift register circuit, by improving not only an image flicker phenomenon caused by an unstable OFF voltage, which is a problem in a conventional driving circuit of a liquid crystal display including four thin film transistors and two capacitors, but also a malfunction problem of a circuit resulting from characteristic variation of thin film transistors caused by DC voltage stress continuously applied to reset transistors, which are problems in another conventional driving circuit of a liquid crystal display including six thin film transistors.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A driving circuit of a liquid crystal display, the driving circuit comprising:
first and second transistors connected in series with each other between an output terminal of an (N−1)^{th} circuit and a Vss terminal;
a third transistor operated by a clock signal, and having a drain for receiving an inversion signal of the clock signal and a source connected to an N^{th} gate line;
a fourth transistor having a drain connected to the source of the third transistor and a source connected to the Vss terminal;
fifth and sixth transistors connected in series with each other between a VDD terminal and the Vss terminal;
a seventh transistor operated by an output signal of an (N+1)^{th} circuit, and having a drain and a source connected to a drain and a source of the second transistor, respectively;
an eighth transistor operated by an output signal of an (N+1)^{th} circuit, and having a drain and a source connected to a drain and a source of the fifth transistor, respectively;
a first capacitor formed at a front terminal of a gate of the third transistor; and
a second capacitor formed between a gate and a drain of the sixth transistor.

2. The driving circuit as claimed in claim 1, wherein, operation states of the first and sixth transistors are determined according to an output signal of the (N−1)^{th} circuit, operation states of the seventh and eighth transistors are determined according to an output signal of the (N+1)^{th} circuit, operation states of the third transistor are determined according to the clock signal, operation states of the second and fourth transistors are determined according to a drain voltage of the sixth transistor, and operation states of the fifth transistor are determined according to a VDD voltage.

3. The driving circuit as claimed in claim 2, wherein, the VDD voltage has a voltage range for allowing gate-source voltages larger than threshold voltages of the second, fourth, and fifth transistors to be applied to the second, fourth, and fifth transistors.

4. The driving circuit as claimed in claim 1, wherein, the seventh transistor is a reset transistor, which is operated by an output signal of the (N+1)^{th} circuit, and the eighth transistor is a transistor for transferring the VDD voltage, which is operated by the output signal of the (N+1)^{th} circuit.

5. The driving circuit as claimed in claim 1, wherein, the first capacitor stabilizes an OFF characteristic of a signal outputted to an N^{th} gate line, and the second capacitor stabilizes a level of a drain voltage of the sixth transistor.
